(19) United States
(12) Patent Application Publication
(10) Pub. No.: US 2015/0060321 A1
(43) Pub. Date: Mar. 5, 2015

(54) CONNECTING ASSEMBLY AND STORAGE UNIT ASSEMBLY WITH THE SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: MAN-ZHONG WANG, Shenzhen (CN)

(21) Appl. No.: 14/476,977

(22) Filed: Sep. 4, 2014

(30) Foreign Application Priority Data
Sep. 5, 2013 (CN) 2013103985706

(51) Int. Cl. B65D 21/02; F16B 12/40

(52) U.S. Cl. CPC B65D 21/0204; F16B 12/40
USPC 206/512; 403/14

(57) ABSTRACT

A connecting assembly includes a first connecting device, a second connecting device, a guide member, and a locking assembly. The first connecting device defines a first through hole. The second connecting device defines a second through hole, and has a latching member protruding from the inner surface of the second connecting device and extending into the second through hole. The guide member defines a first guiding slot and a second guiding slot coupled to the first guiding slot. The first connecting device is fixed to the guide member. The locking assembly has a bar, a locking block, and a sliding block. The locking block is fixed to the top of the bar. The sliding block protrudes from the lateral side of the bar and is received in the first guiding slot.

### CROSS-REFERENCE TO RELATED APPLICATIONS

This application claims priority to Chinese Patent Application No. 201310398570.6 filed on Sep. 5, 2013 in the China Intellectual Property Office, the contents of which are incorporated by reference herein.

### FIELD

The subject matter herein generally relates to connecting assemblies, and particularly, to a connecting assembly capable of connecting two stackable storage units.

### BACKGROUND

In a workshop, stackable storage units need to be stacked together and transported to different locations.

### BRIEF DESCRIPTION OF THE DRAWINGS

Implementations of the present technology will now be described, by way of example only, with reference to the attached figures.

FIG. 1 is an isometric view showing an embodiment of a storage unit assembly.

FIG. 2 is an isometric view showing an embodiment of an inner view of a first stackable storage unit of the storage unit assembly of FIG. 1.

FIG. 3 is an isometric view showing an embodiment of a connecting assembly of the storage unit assembly of FIG. 1.

FIG. 4 is an exploded, isometric view showing the connecting assembly of FIG. 3.

FIG. 5 is a partial cross-sectional view of the connecting assembly of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

Embodiments of the present disclosure will be described in relation to the accompanying drawings.

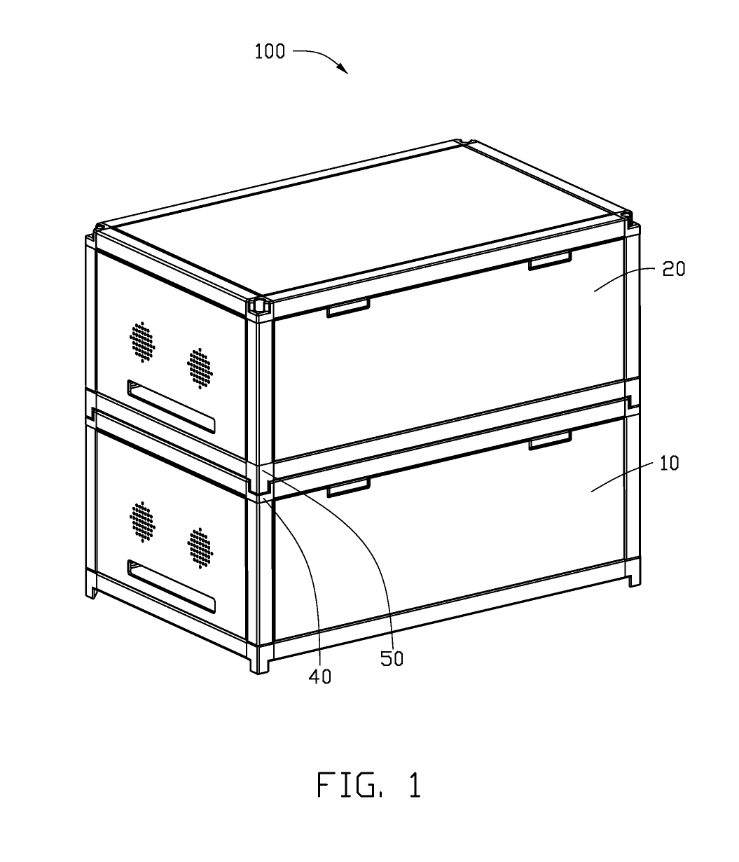

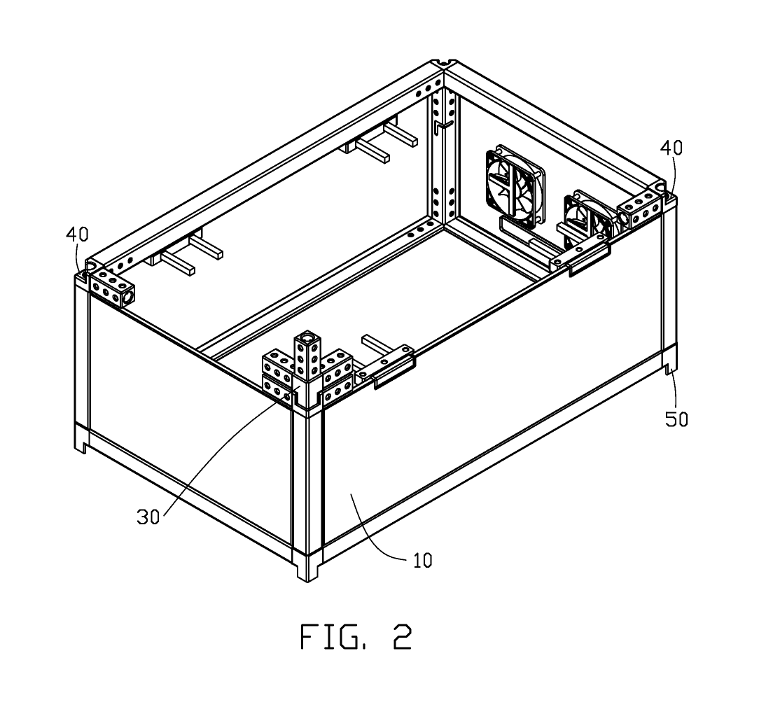

FIGS. 1-2 illustrate an embodiment of a storage unit assembly 100. The storage unit assembly 100 can include a first stackable storage unit 10, a second stackable storage unit 20, and at least one connecting assembly 30. The second stackable storage unit 20 can be stacked on the first stackable storage unit 10. The at least one connecting assembly 30 can connect the second stackable storage unit 20 to the first stackable storage unit 10 when the second stackable storage unit 20 is stacked on the first stackable storage unit 10.

The first stackable storage unit 10 and the second stackable storage unit 20 have a same structure. For simplicity, the first stackable storage unit 10 will be described below in detail, it is understood that the structure of the second stackable storage unit 20 is analogous with the first stackable storage unit 10. The first stackable storage unit 10 can be a substantially rectangular parallelepiped. For simplicity, one connecting assembly 30 will be described in detail below. It is understood that the connecting assemblies 30 included in the storage unit assembly 100 are mutually analogous.

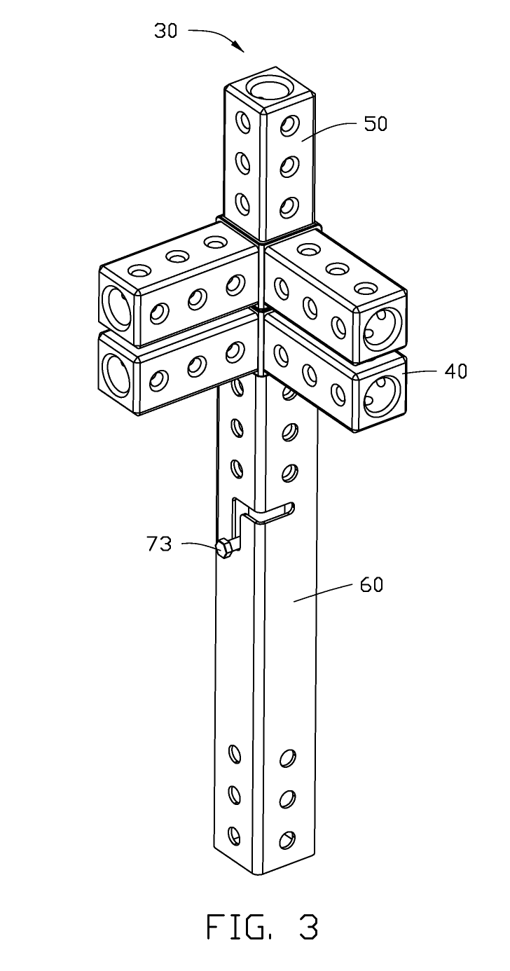

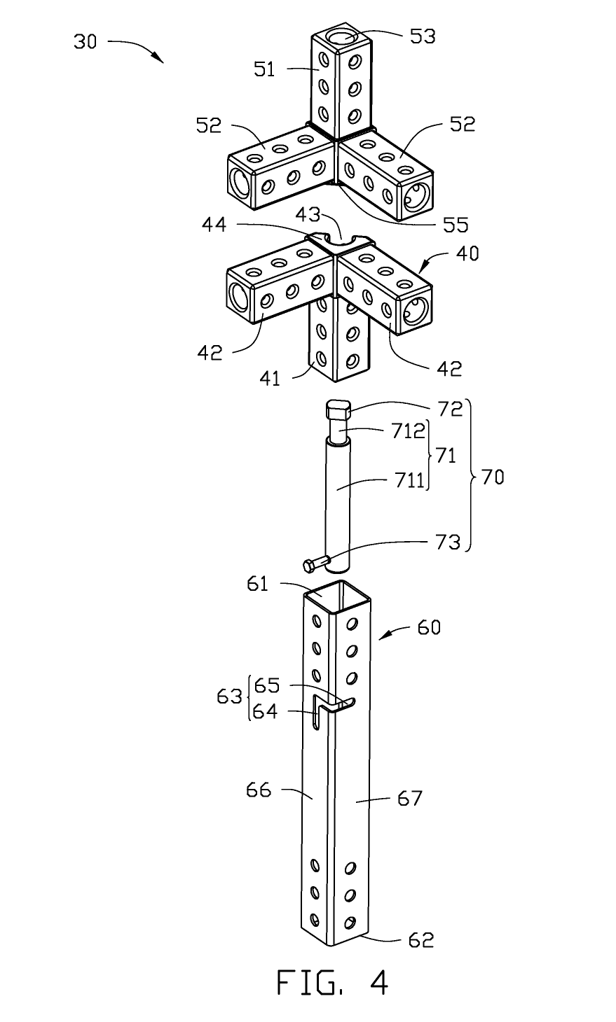

FIGS. 3-5 illustrate that the connecting assembly 30 can include a first connecting device 40, a second connecting device 50, a guide member 60, and a locking assembly 70.

The first connecting device 40 can include a first vertical connecting member 41 and two first horizontal connecting members 42. The first vertical connecting member 41 and the two first horizontal connecting members 42 can be connected to each other and be substantially perpendicularly to each other. In the embodiment, the first horizontal connecting members 42 can be connected to the top of the first vertical connecting member 41. The first vertical connecting member 41 can define a first through hole 43 extending along the height of the first vertical connecting member 41. The top of the first vertical connecting member 41 can have a first supporting member 44. The first supporting member 44 can include a portion protruding from the top of the first vertical connecting member 41, can include a gap defined in the top of the first vertical connecting member 41, or can include a flat surface.

The second connecting device 50 can include a second vertical connecting member 51 and two second horizontal connecting members 52. The second vertical connecting member 51 and the second horizontal connecting members 52 can be connected to each other and be substantially perpendicularly to each other. In the embodiment, the two second horizontal connecting members 52 can be connected to the bottom of the second vertical connecting member 51. The second vertical connecting member 51 can define a second through hole 53 extending along the height of the second vertical connecting member 51. The second vertical connecting member 51 can further include a latching member 54. The latching member 54 can protrude from the inner surface of the second vertical connecting member 51 and extend into the second through hole 53. In the embodiment, the bottom of the second vertical connecting member 51 can have a second supporting member 55 matching with the first supporting member 44. When the first supporting member 44 includes a portion protruding from the top of the first vertical connecting member 41, the second supporting member 55 includes a gap defined in the bottom of the second vertical connecting member 51. When the first supporting member 44 includes a gap defined in the top of the first vertical connecting member 41, the second supporting member 55 includes a portion protruding from the bottom of the second vertical connecting member 51. When the first supporting member 44 includes a flat surface, the second supporting member 55 includes a flat surface.

The guide member 60 can extend upward from the bottom of the first stackable storage unit 10 and is fixed to the first stackable storage unit 10. The guide member 60 can include an open top end 61 and an open bottom end 62. The guide member 60 can be hollow. The bottom of the first vertical connecting member 41 can be inserted into the guide member 60 through the open top end 61, thus the first connecting device 40 is fixed to the first stackable storage unit 10. The second connecting device 50 is fixed to the second stackable storage unit 20. In the embodiment, the top of the second vertical connecting member 51 can be inserted into another guide member 60 of another connecting assembly 30 through the open bottom end 62 of another guide member 60. The guide member 60 can define a guiding slot 63. The guiding slot 63 can include a first guiding slot 64 and a second guiding slot 65 coupled to the first guiding slot 64. In the embodiment, the guide member 60 can include a first sidewall 66 and a second sidewall 67. The first sidewall 66 can define a first guiding slot 64. The second sidewall 67 can define a second guiding slot 65. In the embodiment, the first guiding slot 64 and the second guiding slot 65 can be substantially perpendicular to each other and are coupled to each other to form an inverted L-shaped slot.

The locking assembly 70 can be slidable and received in the guide member 60. The locking assembly 70 can include a bar 71, a locking block 72, and a sliding block 73. In the embodiment, the bar 71 can include a first sleeve 711 and a second sleeve 712. The diameter of the second sleeve 712 can be less than the diameter of the first sleeve 711 and the second sleeve 712 can be partially fixed in the first sleeve 711. The locking block 72 can be attached to the top end of the second sleeve 712 and cooperate with the second sleeve 712 to form an inverted step shape. In the embodiment, a size of the locking block 72 can be less than a size of the first through hole 43 and can be less than a size of the second through hole 53. The sliding block 73 can protrude from the lateral side of the first sleeve 711. The sliding block 73 can be partially received in the guiding slot 63 and partially exposed from the guiding slot 63, thus the sliding block 73 can be operated by a user. In the initial state, the sliding block 73 is received in the first guiding slot 64.

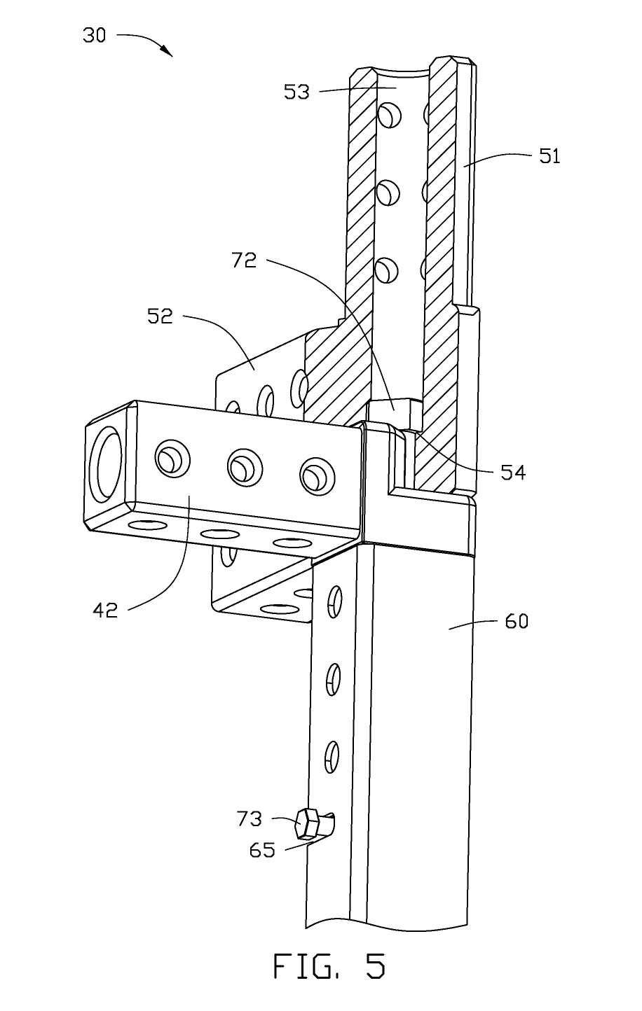

When connecting the second stackable storage unit 20 to the first stackable storage unit 10, the second stackable storage unit 20 is stacked on the first stackable storage unit 10, the second through hole 53 of the second connecting device 50 can be aligned with the first through hole 43 of the first connecting device 40 (see FIG. 3). The sliding block 73 is pushed until moved to an intersection of the first guiding slot 64 and the second guiding slot 65 along the first guiding slot 64. The sliding block 65 can push the locking block 72 to pass through the first through hole 43 of the first connecting device 40 and be received in the second through hole 53 of the second connecting device 50. At this time, the bottom of the locking block 72 can be located above the top of the latching member 54 of the second connecting device 50. The sliding block 73 is pushed again until moved to a first predetermined position along the second guiding slot 65. In the embodiment, the first predetermined position is the end of the second guiding slot 65. The locking block 72 can be brought by the sliding block 73 to engage with the latching member 54 of the second connecting device 50. Thus, the second connecting device 50 can be connected to the first connecting device 40, and the second stackable storage unit 20 can be accordingly latched to the first stackable storage unit 10 through the connecting assembly 30 (see FIG. 5).

When separating the second stackable storage unit 20 from the first stackable storage unit 10, the sliding block 73 is pushed until moved to the intersection of the first guiding slot 64 and the second guiding slot 65 along the second guiding slot 65. The locking block 72 can be brought by the sliding block 73 to move to disengage from the latching member 54 of the second connecting device 50. The sliding block 73 is pushed again until moved to a second predetermined position along the first guiding slot 64. In the embodiment, the second predetermined position is the end of the first guiding slot 64. The locking block 72 can be brought by the sliding block 73 to pass through the second through hole 53 of the second connecting device 50 and be received in the first through hole 43 of the first connecting device 40. Thus, the second stackable storage unit 20 can be detached from the first stackable storage unit 10.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A connecting assembly comprising:
a first connecting device defining a first through hole;
a second connecting device defining a second through hole, and having a latching member protruding from the inner surface of the second connecting device and extending into the second through hole;
a guide member defining a first guiding slot and a second guiding slot coupled to the first guiding slot, and the first connecting device being fixed to the guide member; and
a locking assembly having a bar, a locking block, and a sliding block, the locking block being fixed to the top of the bar, and the sliding block protruding from the lateral side of the bar and being received in the first guiding slot;
wherein when the second through hole of the second connecting device is aligned with the first through hole of the first connecting device, the sliding block is pushed to move to an intersection of the first guiding slot and the second guiding slot along the first guiding slot, the locking block is brought by the sliding block to pass through the first through hole and be received in the second through hole; and the sliding block is pushed again to move a first predetermined position along the second guiding slot, and the locking block is brought by the sliding block to engage with the latching member, to connect the second connecting device to the first connecting device.

2. The connecting assembly as described in claim 1, wherein the guide member has a first sidewall and a second sidewall, the first sidewall defines a first guiding slot and the second sidewall defines a second guiding slot, the first guiding slot and the second guiding slot are substantially perpendicular to each other, and are coupled to each other to form an inverted L-shaped slot.

3. The connecting assembly as described in claim 1, wherein the bar has a first sleeve and a second sleeve, the second sleeve is partially fixed in the first sleeve, a diameter of the second sleeve is less than a diameter of the first sleeve, and the locking block is attached to the top end of the second sleeve and cooperates with the second sleeve to form an inverted step shape.

4. The connecting assembly as described in claim 1, wherein the first connecting device has a first vertical connecting member and two first horizontal connecting members, the first horizontal connecting members are connected to the top of the first vertical connecting member and are substantially perpendicularly to each other, the first through hole is defined in the first vertical connecting member and extends along the height of the first vertical connecting member; the guide member has an open top end and is hollow, and the bottom of the first vertical connecting member is inserted into the guide member through the open top end.

5. The connecting assembly as described in claim 1, wherein the second connecting device has a second vertical connecting member and two second horizontal connecting members, the second horizontal connecting members are connected to the bottom of the second vertical connecting member and are substantially perpendicularly to each other, the second through hole is defined in the second vertical connecting member and extends along the height of the second vertical connecting member; and the guide member has an open bottom end and is hollow, and the top of the second vertical connecting member is inserted into another guide member through the open bottom end.

6. The connecting assembly as described in claim 1, wherein the first connecting device has a first vertical connecting member, the top of the first vertical connecting member has a first supporting member; and the second connecting device has a second vertical connecting member, and the bottom of the second vertical connecting member has a second supporting member matching with the first supporting member.

7. The connecting assembly as described in claim 6, wherein what the first supporting member includes is selected from a group consisting of a portion protruded from the top of the first vertical connecting member, a gap defined in the top of the first vertical connecting member, and a flat surface.

8. A storage unit assembly comprising:
a first stackable storage unit;
a second stackable storage unit; and
a connecting assembly comprising:
a first connecting device defining a first through hole;
a second connecting device fixed to the second stackable storage unit, the second connecting device defining a second through hole, and having a latching member protruding from the inner surface of the second connecting device and extending into the second through hole;
a guide member fixed to the first stackable storage unit, the guide member defining a first guiding slot and a second guiding slot coupled to the first guiding slot, and the first connecting device being fixed to the guide member; and
a locking assembly having a bar, a locking block, and a sliding block, the locking block being fixed to the top of the bar, and the sliding block protruding from the lateral side of the bar and being received in the first guiding slot;
wherein when the second stackable storage unit is stacked on the first stackable storage unit, the second through hole of the second connecting device is aligned with the first through hole of the first connecting device, the sliding block is pushed to move to an intersection of the first guiding slot and the second guiding slot along the first guiding slot, and the locking block is brought by the sliding block to pass through the first through hole and be received in the second through hole; the sliding block is pushed again to move a first predetermined position along the second guiding slot, the locking block is brought by the sliding block to engage with the latching member, to connect the second connecting device to the first connecting device, and the second stackable storage unit is accordingly latched to the first stackable storage unit.

9. The storage unit assembly as described in claim 8, wherein the guide member has a first sidewall and a second sidewall, the first sidewall defines a first guiding slot and the second sidewall defines a second guiding slot, the first guiding slot and the second guiding slot are substantially perpendicular to each other, and are coupled to each other to form an inverted L-shaped slot.

10. The storage unit assembly as described in claim 8, wherein the bar has a first sleeve and a second sleeve, the second sleeve is partially fixed in the first sleeve, a diameter of the second sleeve is less than a diameter of the first sleeve, and the locking block is attached to the top end of the second sleeve and cooperates with the second sleeve to form an inverted step shape.

11. The storage unit assembly as described in claim 8, wherein the first connecting device has a first vertical connecting member and two first horizontal connecting members, the first horizontal connecting members are connected to the top of the first vertical connecting member and are substantially perpendicularly to each other, and the first through hole is defined in the first vertical connecting member and extends along the height of the first vertical connecting member; the guide member has an open top end and is hollow, and the bottom of the first vertical connecting member is inserted into the guide member through the open top end.

12. The storage unit assembly as described in claim 8, wherein the second connecting device has a second vertical connecting member and two second horizontal connecting members, the second horizontal connecting members are connected to the bottom of the second vertical connecting member and are substantially perpendicularly to each other, and the second through hole is defined in the second vertical connecting member and extends along the height of the second vertical connecting member; the guide member has an open bottom end and is hollow, and the top of the second vertical connecting member is inserted into another guide member through the open bottom end.

13. The storage unit assembly as described in claim 8, wherein the first connecting device has a first vertical connecting member, the top of the first vertical connecting member has a first supporting member; and the second connecting device has a second vertical connecting member, the bottom of the second vertical connecting member has a second supporting member matching with the first supporting member.

14. The storage unit assembly as described in claim 13, wherein what the first supporting member includes is selected from a group consisting of a portion protruded from the top of the first vertical connecting member, a gap defined in the top of the first vertical connecting member, and a flat surface.
